(19) United States
(12) Patent Application Publication
(10) Pub. No.: US 2014/0234685 A1
(43) Pub. Date: Aug. 21, 2014

(54) MOLTEN SALT BATTERY

(71) Applicants: Koji Nitta, Osaka-shi (JP); Shinji Inazawa, Osaka-shi (JP); Shoichiro Sakai, Osaka-shi (JP); Atsushi Fukunaga, Osaka-shi (JP)

(72) Inventors: Koji Nitta, Osaka-shi (JP); Shinji Inazawa, Osaka-shi (JP); Shoichiro Sakai, Osaka-shi (JP); Atsushi Fukunaga, Osaka-shi (JP)

(73) Assignee: SUMITOMO ELECTRIC INDUSTRIES, LTD., Osaka-shi, Osaka (JP)

(21) Appl. No.: 14/009,252

(22) PCT Filed: Mar. 26, 2012
(86) PCT No.: PCT/JP2012/057703

§ 371 Date: Oct. 1, 2013

(30) Foreign Application Priority Data
Apr. 1, 2011 (JP) 2011-082049

(51) Int. Cl. H01M 10/39

(52) U.S. Cl. CPC H01M 10/399
USPC 429/112

(57) ABSTRACT

A separator for use in a molten salt battery has the problem that due to usage specific to the molten salt battery, the separator is placed under mechanical, thermal and chemical stress, so that cracking or rupture easily occurs, leading to a degradation in battery performance such as an internal short-circuit. The molten salt battery of the present invention includes a separator containing a metal oxide, particularly aluminum oxide and/or zirconium oxide in an amount of 75% or more. The separator improves mechanical, thermal and chemical resistance, and thus an internal short-circuit ascribable to the separator is hard to occur, so that the molten salt battery can be stably operated for a long period of time. The separator has high heat stability, so that the safety of the molten salt battery can be improved.

### TECHNICAL FIELD

The present invention relates to a molten salt battery using a molten salt as an electrolyte.

### BACKGROUND ART

In recent years, use of natural energy such as sunlight and wind power has been promoted. When electric power is generated using natural energy, the amount of electric power is easily varied, and therefore leveling of electric power supply by charge/discharge using a storage battery is necessary for stably supplying generated electric power. Accordingly, a storage battery for storage of electric power, which has a high energy density/high efficiency, is absolutely necessary for promoting use of natural energy. Such storage batteries for storage of electric power include a molten salt battery in addition to the sodium-sulfur battery and lead acid battery described in Patent Literature 1.

The molten salt battery described in Patent Literature 2 is a battery using a molten salt for an electrolyte, and operates as the molten salt is melted. As the molten salt, for example, NaFSA with the sodium ion as a cation and FSA (bisfluorosulfonylamide; (FSO2)2N—) as an anion is used. The melting point of the molten salt is equal to or higher than room temperature, and a molten salt battery using the molten salt operates at a temperature higher than room temperature, for example around 100° C. In addition to the electrolyte, a positive electrode, a negative electrode and a separator are included in the molten salt battery. These members are required to have heat resistance.

The separator is a sheet-shaped member for isolating the positive electrode and the negative electrode from each other, and retains therein a molten salt containing ions of an active material. In a conventional molten salt battery, a separator made of glass, which uses a glass cloth, or a separator of polyolefin resin which is used in a lithium ion secondary battery or the like is used.

### CITATION LIST

### Patent Literatures

Patent Literature 1: Japanese Unexamined Patent Publication No. 2007-273297

Patent Literature 2: Japanese Unexamined Patent Publication No. 2011-192474

### SUMMARY OF INVENTION

### Technical Problem

A generally well known lithium ion secondary battery, nickel-metal hydride storage battery, or the like can be used at ordinary temperature, but a molten salt battery is a battery which operates at a temperature higher than ordinary temperature, i.e., about 80 to 100° C. Therefore, when the battery is operated, heating is required to elevate the temperature of the whole of the battery to a temperature equal to or higher than the melting point of a molten salt as an electrolyte so that the electrolyte of the battery is brought into a liquid state. At the time of stopping the battery, the electrolyte is solidified and thus can no longer function as an electrolyte when heating of the battery is stopped to decrease the temperature of the electrolyte to a melting point or lower.

In this way, in the molten salt battery, the electrolyte alternates between a liquid state and a solid state as the battery is alternately operated and stopped. Due to this solid-liquid state change of the electrolyte, a conventional separator material is placed under mechanical stress, heat and chemical stress especially by the electrolyte existing in the separator. As a result, there is the problem that cracking and rupture easily occur, leading to a degradation battery performance such as an internal short-circuit.

The present invention has been devised in view of the situation described above, and an object thereof is to provide a molten salt battery which stably functions even when an electrolyte alternates between a liquid state and a solid state as the battery is alternately operated and stopped.

### Solution to Problem

The present invention provides a molten salt battery using a molten salt as an electrolyte, the molten salt battery comprising a positive electrode, a negative electrode and a separator existing between the positive electrode and the negative electrode to isolate both the electrodes from each other, the separator containing a metal oxide material in an amount of 75% by mass or more.

For example, a separator containing aluminum oxide and/or zirconium oxide in an amount of 75% by mass or more is preferred.

On the other hand, for example, a remainder of components of the separator may include other metal oxides with substantially no organic compound contained. Alternatively, the reminder of components of the separator may include an organic compound. As the organic compound, for example, polyolefin or polyamide is preferred.

In recent years, for example, various kinds of heat-resistant separators to improve safety, the separator including an inorganic fine particle layer on a microporous film made of polyolefin, have been proposed as a separator for a lithium ion secondary battery using an organic electrolyte. In contrast, the aforementioned specific operation method is used for a molten salt battery using a molten salt as an electrolyte. Therefore, a material specific to the molten salt battery is used for the separator, and the separator is required to have an unprecedented function for satisfactorily operating the battery.

The separator in the molten salt battery of the present invention contains a metal oxide, particularly aluminum oxide and/or zirconium oxide in an amount of 75% by mass or more. Consequently, a function of a mechanically and chemically stable separator can be maintained even when the electrolyte alternates between a liquid state and a solid state as the battery is alternately operated and stopped. The separator containing aluminum oxide and/or zirconium oxide in an amount of 75% by mass or more not only has high mechanical strength in a heat cycle, but also has high chemical stability to the electrolyte even at a relatively high operating temperature.

Further, the molten salt battery of the present invention has such a characteristic of high safety that the risk of heat generation/ignition or the like is extremely low even if an abnormal situation such as an internal short-circuit is encountered because an incombustible electrolyte material is used. The reason for this is that the incombustible electrolyte material exists throughout electric power generation element parts such as the positive electrode, the negative electrode and the separator of the molten salt battery. That is, even if water or the like enters from outside the battery due to an accident or the like, or a short-circuit occurs in the battery, the incombustible electrolyte material protects a part where an abnormality may occur, so that an onset of local abnormal heat generation is prevented. This is the reason why the molten salt battery can ensure high safety.

### Advantageous Effects of Invention

According to the present invention, a mechanically and chemically stable function can be maintained. Therefore, there can be provided a molten salt battery which stably functions even when an electrolyte alternates between a liquid state and a solid state as the battery is alternately operated and stopped, i.e., the problem of conventional molten salt batteries can be solved.

In addition, there can be provided a molten salt battery with high safety in which the risk of heat generation/ignition or the like is extremely low even if an abnormal situation such as an internal short-circuit is encountered.

### BRIEF DESCRIPTION OF DRAWING

FIG. 1 is a schematic sectional view showing an example of a configuration of a molten salt battery of the present invention.

### DESCRIPTION OF EMBODIMENTS

Hereinbelow, the present invention will be specifically described with reference to the drawings showing embodiments thereof.

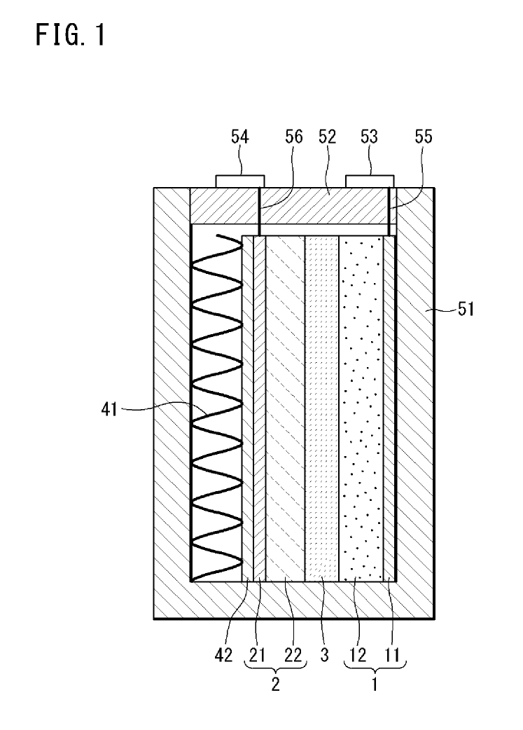

FIG. 1 is a schematic sectional view showing an example of a configuration of a molten salt battery of the present invention. FIG. 1 shows a schematic sectional view of the molten salt battery when cut in a longitudinally direction. The molten salt battery is formed by arranging a positive electrode 1, a separator 3 and a negative electrode 2 side by side in a rectangular-parallelepiped box-shaped battery container 51 which is opened at an upper surface, and firmly fixing a lid portion 52 to the battery container 51. The battery container 51 and the lid portion 52 are formed of aluminum.

The positive electrode 1 and the negative electrode 2 are formed in a rectangular flat shape, and the separator 3 is formed in a sheet shape. The separator 3 is interposed between the positive electrode 1 and the negative electrode 2, and isolates the positive electrode 1 and the negative electrode 2 from each other so as not be short-circuited. The positive electrode 1, the separator 3 and the negative electrode 2 are stacked on one another, and normally arranged longitudinally with respect to the bottom surface of the battery container 51.

A spring 41 formed of a corrugated plate-shaped metal is placed between the negative electrode 2 and the inner side wall of the battery container 51. A flat plate-shaped presser plate 42 is formed of an aluminum alloy and has non-flexibility. The spring 41 energizes the presser plate 42 to press the negative electrode 2 to the separator 3 and positive electrode 1 side. By a counterforce to the pressing force, the positive electrode 1 is pressed to the separator 3 and negative electrode 2 side from the inner side wall on a side opposite to the spring 41. The spring 41 is not limited to a metallic spring or the like, and may be an elastic body such as rubber. When the positive electrode 1 or the negative electrode 2 is expanded or contracted due to charge-discharge, a change in volume of the positive electrode 1 or the negative electrode 2 is absorbed by expansion and contraction of the spring 41.

The positive electrode 1 is formed by applying a positive electrode material 12, which contains a positive electrode active material such as NaCrO₂ and a binder, onto a rectangular plate-shaped current collector of positive electrode 11 formed of aluminum. The positive electrode active material is not limited to NaCrO₂. The negative electrode 2 is formed by applying a negative electrode material 22, which contains a negative electrode active material such as tin, onto a rectangular plate-shaped current collector of negative electrode 21 formed of aluminum using plating, a deposition method or the like. When the current collector of negative electrode 21 is plated thereon with the negative electrode material 22, a substrate is plated with zinc, and then plated with tin as a zincate treatment. The negative electrode active material is not limited to tin, and for example, tin may be replaced by metal sodium, carbon, silicon or indium. The negative electrode material 22 may be formed by, for example, including a binder in a powder of the negative electrode active material, and applying the powder onto the current collector of negative electrode 21. Details of the separator 3 will be described later.

In the battery container 51, the positive electrode material 12 of the positive electrode 1 and the negative electrode material 22 of the negative electrode 2 are made to face each other, and the separator 3 is interposed between the positive electrode 1 and the negative electrode 2. The positive electrode 1, the negative electrode 2 and the separator 3 are impregnated with an electrolyte formed of a molten salt. The inner surface of the battery container 51 is structured to have an electrically insulating property by a method of coating the surface with a resin having an electrically insulating property in order to prevent a short-circuit between the positive electrode 1 and the negative electrode 2.

On the outer side of the lid portion 52, a positive electrode terminal 53 and a negative electrode terminal 54 for establishing a connection to the outside are provided. The positive electrode terminal 53 and the negative electrode terminal 54 are insulated from each other, and a part of the lid portion 52 which faces the inside of the battery container 51 is also insulated by an insulating film or the like. One end of the current collector of positive electrode 11 is connected to the positive electrode terminal 53 by a lead wire 55, while one end of the current collector of negative electrode 21 is connected to the negative electrode terminal 54 by a lead wire 56. The lead wire 55 and the lead wire 56 are insulated from the lid portion 52. The lid portion 52 is firmly fixed to the battery container 51 by welding.

The electrolyte of the molten salt battery is a molten salt which is a conductive liquid in a molten state. At a temperature equal to or higher than the melting point of the molten salt, the molten salt is melted into an electrolytic solution, and the molten salt battery operates as a secondary battery. It is desirable that in the electrolyte, a plurality of molten salts be mixed for lowering the melting point. For example, the electrolyte is a mixed salt of NaFSA with the sodium ion as a cation and FSA as an anion, and KFSA with the potassium ion as a cation and FSA as an anion.

The molten salt as an electrolyte may contain other anions such as TFSA (bistrifluoromethylsulfonylamide) or FTA (fluorotrifluoromethylsulfonylamide), and may contain other cations such as organic ions. In this form, sodium ions are carriers of charges in the electrolyte.

The configuration of the molten salt battery shown in FIG. 1 is a schematic configuration, and other components (not shown) such as a heater for heating the inside or a temperature sensor may be included in the molten salt battery. FIG. 1 shows a principal configuration in which a pair of the positive electrode 1 and the negative electrode 2 is provided, but a more practical molten salt battery of the present invention may have a configuration in which a plurality of positive electrodes 1 and negative electrodes 2 are alternately arranged, and mutually superimposed with the separator 3 sandwiched between both the adjacent electrodes.

Next, details of the separator 3 will be described. The separator 3 is a sheet-shaped member having Al₂O₃ (aluminum oxide) or ZrO₂ (zirconium oxide) as main components. The separator 3 is impregnated therein with the molten salt, and has a porous structure so that carriers of charges are transferred between the positive electrode 1 and the negative electrode 2.

For example, the separator 3 is a woven fabric or nonwoven fabric formed of fibers having Al₂O₃ as a main component, or a woven fabric or nonwoven fabric formed of fibers having ZrO₂ as a main component. The separator 3 may be configured to have both Al₂O₃ and ZrO₂, such as a nonwoven fabric formed by mixing fibers having Al₂O₃ as a main component and fibers having ZrO₂ as a main component. The separator 3 may be non-fibrous sheet having Al₂O₃ or ZrO₂ as a main component.

The content of Al₂O₃ and/or ZrO₂ contained in the separator 3 in the present invention is 75% or more in terms of % by mass. In the separator 3, the content of Al₂O₃ alone may be 75% by mass or more, or the content of ZrO₂ alone may be 75% by mass or more. The content of the total of Al₂O₃ and ZrO₂ may be 75% by mass or more.

Since the content of Al₂O₃ and/or ZrO₂ is 75% by mass or more, the separator 3 can maintain a function of a mechanically and chemically stable separator, and there can be provided a molten salt battery which stably functions even when an electrolyte alternates between a liquid state and a solid state as the battery is alternately operated and stopped, i.e., the problem of conventional molten salt batteries can be solved.

In addition, there can be provided a molten salt battery with high safety in which the risk of heat generation/ignition or the like is extremely low even if an abnormal situation such as an internal short-circuit is encountered.

It is desirable that the content of Al₂O₃ and/or ZrO₂ contained in the separator 3 be 100% by mass in principle. However, other metal oxides other than Al₂O₃ and ZrO₂ and an organic compound may be contained as components (remainders) of the separator 3 in an amount of 25% by mass or less from the viewpoint of cost reduction and shape retention of the separator. Also in this case, an effect similar to that of a separator formed of pure Al₂O₃ and/or ZrO₂ can be exerted.

As the other metal oxides other than Al₂O₃ and ZrO₂, silica (SiO₂), yttria (Y₂O₃), titania (TiO₂), ceria (CeO₂) and the like can be used.

As the organic compound, one that is frequently used as a separator for a lithium ion secondary battery can be used. This is, for example, an organic compound of a polyolefin such as polyethylene (PE) or polypropylene (PP), a polyamide such as nylon or aramid, or the like.

Examples of the separator having Al₂O₃ and/or ZrO₂ as a main component include those formed by integrating fibers of these metal oxides into a sheet such as a felt (nonwoven fabric) or a cloth (woven fabric), and those formed by integrating powders (particles) of these metal oxides into a sheet. The other metal oxides other than Al₂O₃ and ZrO₂ act as a binder for integrating them into a sheet.

On the other hand, the organic compound such as a polyolefin or a polyamide similarly acts as a binder for ceramic fibers or powders. Using the organic compound as a material, a nonwoven fabric or a porous organic material sheet having a microporous membrane may be formed like the separator for a lithium ion secondary battery. In this case, two layers of the organic material sheet and a ceramic sheet of an Al₂O₃ and/or ZrO₂ material or the like may be laminated and integrated to form a separator for this molten salt battery. The lamination of these two layers can be performed by thermocompression bonding.

These separators of the present invention are excellent in mechanical, thermal and chemical resistance among electrolytes that are used around 100° C. As a result of being excellent in mechanical, thermal and chemical resistance, the probability of occurrence of an internal short-circuit ascribable to the separator is extremely low. The separator having Al₂O₃ and/or ZrO₂ as a main component has such a characteristic of high safety that the risk of heat generation/ignition or the like is extremely low even if an abnormal situation such as an internal short-circuit is encountered.

It is desirable that the thickness of the separator 3 be 0.02 to 0.5 mm. If the thickness of the separator 3 is less than 0.02 mm, the strength of the separator 3 having Al₂O₃ or ZrO₂ as a main component is reduced, so that the separator is easily damaged. If the thickness of the separator 3 is more than 0.5 mm, the internal resistance of the molten salt battery is increased, and the volume energy density of the molten salt battery is reduced. It is desirable that the porosity of the separator 3 be 20 to 80%. If the porosity of the separator 3 is less than 20%, the internal resistance of the molten salt battery is increased. If the porosity of the separator 3 is more than 80%, the risk of occurrence of a short-circuit by direct contact of the positive electrode 1 and the negative electrode 2 is increased.

In the above embodiment, the current collector of positive electrode 11 and the current collector of negative electrode 21 are made of aluminum, but may be made of any other electric conductor. The shape of the molten salt battery is not limited to the shape of rectangular parallelepiped, and may be any other shape. For example, the shape of the molten salt battery may be a cylindrical shape.

### EXAMPLES

Next, the present invention will be described further in detail based on Examples. However, Examples are not intended to limit the scope of the present invention.

Durability as a separator for a molten salt battery was evaluated for separators as Examples of the present invention and previously known various separators as Comparative Examples. The configurations of components of separators subjected to the evaluation are shown in Table 1.

TABLE 1

| | Major configuration of separator | |
|---|---|---|
| Battery | (composition: % by mass) | Category |
| A | Al₂O₃, 100% | Present invention |
| B | ZrO₂, 100% | Present invention |
| C | Al₂O₃, 60% ZrO₂, 40% | Present invention |
| D | Al₂O₃, 75% SiO₂, 25% | Present invention |
| E | ZrO₂, 92% Y₂O₃, 8% | Present invention |
| F | Al₂O₃, 80% Polyolefin, 20% | Present invention |
| G | Al₂O₃, 76% Aramid, 24% | Present invention |
| H | Polyolefin, 100% | Comparative Example |
| I | Aramid, 100% | Comparative Example |
| J | Polyolefin, 70% Al₂O₃, 30% | Comparative Example |

Molten salt batteries used for evaluation of durability each have a configuration similar to that in FIG. 1, and all have identical electrolytes, positive electrodes and negative electrodes. Ten molten salt batteries of A to J shown in Table 1, which are only different in separators, were prepared. Batteries prepared using separators of A to G each contain Al₂O₃ and/or ZrO₂ as a metal oxide material in an amount of 75% by mass or more, and belongs to the present invention. On the other hand, batteries prepared using separators of H to J are previously well known batteries of Comparative Examples, and the separators of H and I each contain neither Al₂O₃ nor ZrO₂. The separator of J contains Al₂O₃, but the ratio thereof is only 30%.

The molten salt batteries of A to J prepared using the separators of A to J were evaluated as follows. Specifically, the prepared batteries of A to J were heated to 90° C. Charge and discharge were repeated at 90° C. to confirm that all the batteries of A to J normally had initial battery characteristics. Thereafter, heating of the batteries was stopped, and the batteries were allowed to cool to room temperature.

From this state, the following temperature cycle test was started.
(1) The battery is heated from room temperature to 90° C. for 5 hours.
(2) Constant-voltage charge to 3.5 V at a 90° C.-5 hour rate (0.2 C) and charge-and-rest for 1 hour are performed.
(3) A charge-discharge test of constant-current discharge to a final voltage of 2.8 V at a 5 hour rate (0.2 C) and discharge-and-rest for 1 hour is conducted.
(4) At the time of completion of the above test, heating of the battery was stopped, and the battery was allowed to cool to room temperature.

Charge-discharge characteristic data were observed while the temperature cycle test of repeating a series of step of temperature elevation, charge-discharge and temperature lowering in (1) to (4) above was conducted.

As a result, in the batteries of H to J of Comparative Examples, a degradation in performance of the battery was observed with a relatively small number of temperature cycle tests as compared to the batteries of A to G. The specific degradation in performance includes a reduction in discharge capacity of the battery, a reduction in open-circuit voltage (OCV) at a leaving time after charging/discharging, and the like. A battery, for which a degradation in performance was observed once, was accelerately degraded in performance in subsequent temperature cycle tests.

In contrast, the batteries of A to G of the present invention maintained stable performance over a time period about two times as long as that for the batteries of H to J of Comparative Examples in terms of the number of temperature cycle tests. That is, according to the present invention, a function of a mechanically and chemically stable separator can be maintained, so that there can be provided a molten salt battery which stably functions even when an electrolyte alternates between a liquid state and a solid state as the battery is alternately operated and stopped.

After the test, the separators of the batteries of H to J, which were degraded in performance, were disassembled and observed to find a situation in which the separator was partially cracked, and even ruptured in a severe case. That is, such a degradation in performance of the battery is ascribable to an internal short-circuit of a battery with a separator interposed therein.

### INDUSTRIAL APPLICABILITY

A molten salt battery of the present invention is capable of being used not only for storage of electric power but also as a general-purpose secondary battery.

### REFERENCE SIGNS LIST

1: POSITIVE ELECTRODE

11: CURRENT COLLECTOR OF POSITIVE ELECTRODE

12: POSITIVE ELECTRODE MATERIAL

2: NEGATIVE ELECTRODE

21: CURRENT COLLECTOR OF NEGATIVE ELECTRODE

22: NEGATIVE ELECTRODE MATERIAL

3: SEPARATOR

1. A molten salt battery using a molten salt as an electrolyte, comprising:
a positive electrode;
a negative electrode; and
a separator existing between the positive electrode and the negative electrode to isolate both the electrodes from each other, the separator containing a metal oxide material in an amount of 75% by mass or more.

2. The molten salt battery according to claim 1, wherein the separator contains aluminum oxide and/or zirconium oxide in an amount of 75% by mass or more.

3. The molten salt battery according to claim 2, wherein a remainder of components of the separator includes other metal oxides with substantially no organic compound contained.

4. The molten salt battery according to claim 1, wherein a remainder of components of the separator includes an organic compound.

5. The molten salt battery according to claim 4, wherein the organic compound is selected from a polyolefin and a polyamide.

6. The molten salt battery according to claim 2, wherein a remainder of components of the separator includes an organic compound.

7. The molten salt battery according to claim 6, wherein the organic compound is selected from a polyolefin and a polyamide.
